(19) United States
(12) Patent Application Publication
(10) Pub. No.: US 2006/0143028 A1
(43) Pub. Date: Jun. 29, 2006

(54) Network analysis system and method using business value

(76) Inventors: Jorn Altmann, Berkeley, CA (US); Lee Rhodes, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/021,414

(22) Filed: Dec. 23, 2004

(51) Int. Cl. G06Q 99/00

(52) U.S. Cl. 705/1

(57) ABSTRACT

A network analysis system and method is disclosed. In one embodiment, the invention includes a method for analyzing a network having a plurality of network links. The method includes determining network subscriber usage associated with each link. A subscriber business value associated with each link is determined. A link business value associated with each link is determined using the network subscriber usage and the subscriber business value.

### CROSS-REFERENCE TO RELATED APPLICATIONS

This application is related to the following concurrently filed U.S. patent application Ser. No. ______, Docket No. 200208403-1; Ser. No. ______, Docket No. 200208404-1; Ser. No. ______, Docket No. 200208405-1; and Ser. No. ______, Docket No. 200208406-1, all of which are incorporated herein by reference.

### BACKGROUND OF THE INVENTION

Network systems are utilized as communication links for everyday personal and business purposes. With the growth of network systems, particularly the Internet and wireless telephone networks, and the advancement of computer hardware and software technology, network use ranges from simple communication exchanges such as electronic mail to more complex and data intensive communication sessions such as web browsing, electronic commerce, and numerous other electronic network services such as Internet voice, and Internet video-on-demand.

Network usage information does not include the actual information exchanged in a communications session between parties, but rather includes metadata (data about data) information about the communication sessions and consists of numerous usage detail records (UDRs). The types of metadata included in each UDR will vary by the type of service and network involved, but will often contain detailed pertinent information about a particular event or communications session between parties such as the session start time and stop time, source or originator of the session, destination of the session, responsible party for accounting purposes, type of data transferred, amount of data transferred, quality of service delivered, etc. In telephony networks, the UDRs that make up the usage information are referred to as a call detail records or CDRs. In Internet networks, usage detail records do not yet have a standardized name, but in this application they will be referred to as internet detail records or IDRs. Although the term IDR is specifically used throughout this application in an Internet example context, the term IDR is defined to represent a UDR of any network.

Network usage information is useful for many important business functions such as subscriber billing, marketing and customer care, and operations management. Network usage data reporting systems are utilized for collecting, correlating, and aggregating network usage information as it occurs and creating UDRs as output that can be consumed by computer business systems that support the above business functions. Examples of these computer business systems include billing systems, marketing and customer relationship management systems, customer churn analysis systems, and data mining systems.

Especially for Internet networks, several important technological changes are key drivers in creating increasing demand for timely and cost-effective analysis of Internet usage information or the underlying IDRs.

One technological change is the dramatically increasing Internet access bandwidth at moderate subscriber cost. Most consumers today have only limited access bandwidth to the Internet via an analog telephony modem, which has a practical data transfer rate upper limit of about 56 thousand bits per second. When a network service provider's subscribers are limited to these slow rates there is an effective upper bound to potential congestion and overloading of the service provider's network. However, the increasing wide scale deployments of broadband Internet access through digital cable modems, digital subscriber line, microwave, and satellite services are increasing the Internet access bandwidth by several orders of magnitude. As such, this higher access bandwidth significantly increases the potential for network congestion and bandwidth abuse by heavy users. With this much higher bandwidth available, the usage difference between a heavy user and light user can be quite large.

Another technological change is the rapid growth of applications and services that require high bandwidth. Examples include Internet telephony, video-on-demand, and complex multiplayer multimedia games. These types of services increase the duration of time that a user is connected to the network as well as requiring significantly more bandwidth to be supplied by the service provider.

Another technological change is the transition of the Internet from “best effort” to “mission critical”. As many businesses are moving to the Internet, they are increasingly relying on this medium for their daily success. This transitions the Internet from a casual, best-effort delivery service into the mainstream of commerce. Business managers will need to have quality of service guarantees from their service provider and will be willing to pay for these higher quality services.

Network usage analysis systems provide information about how the service provider's services are being used and by whom. This is vital business information that a service provider must have in order to identify fast moving trends, establish competitive prices, and define new services or subscriber classes as needed.

For reasons stated above and for other reasons presented in greater detail in the Description of the Preferred Embodiment section of the present specification, more advanced techniques are required in order to more compactly represent key usage information and provide for more timely extraction of the relevant business information from this usage information.

### SUMMARY OF THE INVENTION

Embodiments of the present invention provide a network analysis system and method. In one embodiment, the invention includes a method for analyzing a network having a plurality of network links. The method includes determining network subscriber usage associated with each link. A subscriber business value associated with each link is determined. A link business value associated with each link is determined using the network subscriber usage and the subscriber business value.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram of a network usage analysis system according to the present invention providing representation of network usage information and interactive usage analysis.

FIGS. 2A and 2B illustrate networks on which the network usage analysis system performs its analysis according to the present invention.

FIG. 3 is a flow diagram illustrating one exemplary embodiment of a method for analyzing network usage using subscriber information according to the present invention.

FIG. 4 is a block diagram of an alternative embodiment a network usage analysis system according to the present invention providing representation of network usage information.

FIG. 5 is a block diagram of an alternative embodiment a network usage analysis system according to the present invention providing representation of network usage information and interactive usage analysis.

FIG. 6 is a flow diagram illustrating one exemplary embodiment of a method for analyzing network usage according to the present invention including providing direct statistical representation of usage information, compact storage and real time interactive usage analysis.

### DESCRIPTION OF THE PREFERRED EMBODIMENTS

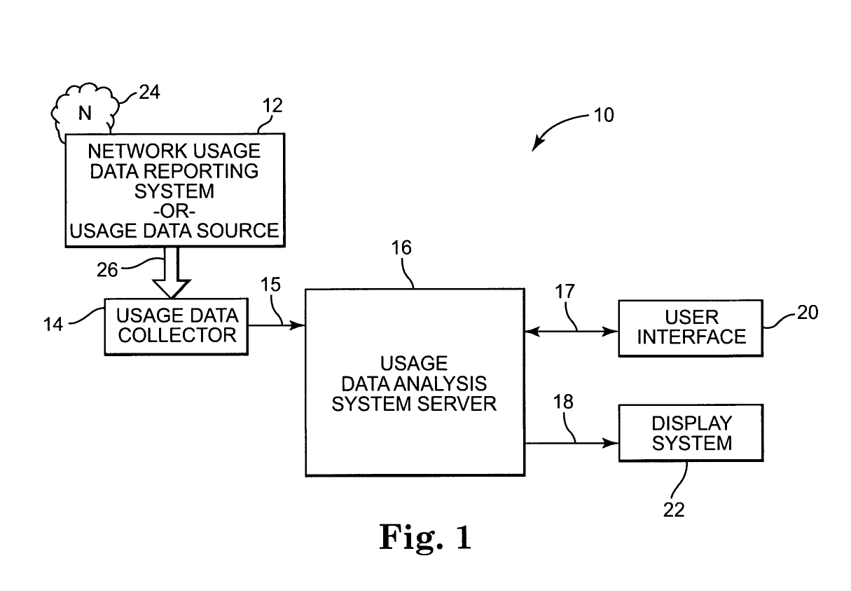

A network usage analysis system according to the present invention is illustrated generally at 10 in FIG. 1. Network usage analysis system 10 includes several main components, each of which comprises a software program. The main software program components of network usage analysis system 10 run on one or more computer or server systems. In one embodiment, each of the main software program components runs on its own computer system.

In one exemplary embodiment, network usage analysis system 10 includes a usage data collector 14, and a usage data analysis system server 16. Usage data collector 14 is coupled to usage data analysis system server 16 via communication link 15. Network usage analysis system 10 further includes user interface 20 and display system 22. User interface 20 and display system 22 are coupled to usage data analysis system server 16 via communication links 17 and 18, respectively.

Usage data collector 14 collects usage data 26 which includes subscriber usage data, associated with a plurality of links within a network. In one embodiment, the usage data 26 is a real time stream of IDRs generated from a usage data source or a network usage data reporting system 12, positioned on a network 24 (also indicated by an “N”). As used herein, a network usage data reporting system 12 is one type of usage data source. Alternatively, the IDRs may be received from a database or central data warehouse. Usage data collector 14 may also collect subscriber business data. Subscriber business data may be separately collected or determined by usage data analysis system server 16.

Usage data analysis system server 16 receives the usage data from usage data collector 14 via communication link 15. In one aspect, usage data collector 14 is separate from network usage data reporting system 12, and in another aspect, usage data collector 14 is part of a network usage data reporting system, such that the usage data analysis system server 16 receives the set of usage data directly from the network usage data reporting system. In another aspect, usage data collector 14 is part of the usage data analysis system server 16. Network 24 may be a plurality of server and host computer networks, such as the Internet, or may be a plurality of wireless networks, such as a cellular phone system.

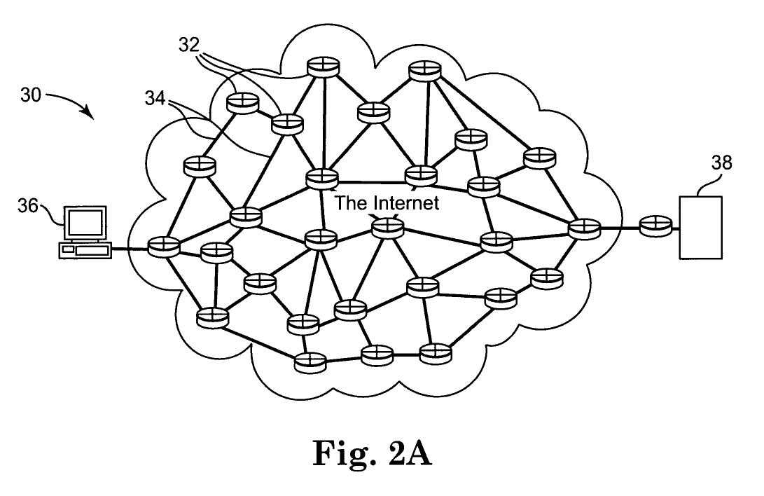

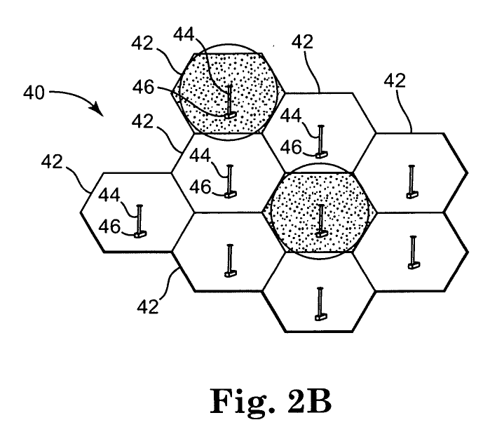

FIG. 2A illustrates an Internet network 30. Internet 30 includes a plurality of network devices (e.g., routers) 32 coupled to each other by a series of links 34. Links 34 may include wire or wireless links, or a combination of these. An access computer 36 and a host computer 38 are illustrated coupled to the network 30. Routers 32 determine the links 34 used to connect access computer 36 to host computer 38. There are many options of various links 34 that can be used to connect access computer 36 to host computer 38. Data, whether in the form of a web-page, a downloaded file or an e-mail message, travels over internet 30 as a packet-switching network system. In this system, the data in a message or in a file is broken up into packages or call packets, which can vary in length from 40 bytes to approximately 1500 bytes or greater in known networks (e.g., the Internet). Each of these packets of data get a wrapper that includes information on the sender's address, the receiver's address the sequence number, (e.g., the packet is placed in the entire message), and how the receiving computer can be sure that the package arrived intact (i.e., handshake or protocol information used by the network to guarantee delivery). Each packet is then sent off to its destination via the best available route—a route that might be taken by all the other packets in the message or by none of the other packets in the message. In other words, routers 32 may send packets from the same message or file over different links 34 to eventually arrive at the same destination.

For example, if there is a problem with one piece of equipment in Internet 30 while a message is being transferred, packets can be routed around the problem, ensuring the delivery of the entire message. Routers 32 that make up the main part of Internet 30 can reconfigure links 34, or the paths, that packets take because they look at the protocol information of the data packet, and they assess line conditions, such as delays in receiving and sending data and traffic on various pieces of the network. Consequently, some links 34 of network 30 may be more used than other links for sending packets.

FIG. 2B illustrates a wireless network 40. Wireless network 40 includes a plurality of cells 42, each of which include a tower 44 and associated transmission equipment 46 for sending and receiving signals. Although wireless network 40 differs in operation from Internet 30, it similarly bundles and transmits data in packets that are transferred from tower 44 to tower 44 from a source to a destination via a plurality of wireless links. Again, the route or path that the packets take can differ, and some cells 42, or links, may be more used than others.

Usage analysis system 10 is used in association with networks such as networks 30 and 40 illustrated in FIGS. 2A and 2B. Usage data source 12 receives usage data 26 and passes usage data 26 to usage data collector 14. Usage data analysis system server 16 then receives and uses usage data 26 to perform analysis on the usage data 26. In addition to the type of service and network involved, information about a particular event or communications session between parties such as the session start time and stop time, source or originator of the session, destination of the session, responsible party for accounting purposes, type of data transferred, amount of data transferred, quality of service delivered, the usage data 26 in the present invention also includes information about the route taken or used in moving from source to destination and information about the customers or subscribers involved in the data transfer, including the time the traffic occurred (i.e., a time stamp). Consequently, usage data analysis system server 16 can track the most and least used routes or links in network 24 and correlate these routes to the subscribers whose data was transferred over them. A network service provider can then use this usage data to make tailored business decisions about the network that are based on this usage data.

In one embodiment, usage analysis system 10 is used to make business decisions about network 24 based on the business value of the links in the network. This includes an analysis of the most used links in network 24, the subscriber identification using the links, the customer (i.e., subscriber) segment using the links, the services being used by the subscribers, the pricing plans of the subscribers, and the relative business value of those subscribers. The subscriber business value can be any kind of information about the subscriber or its value to the business of the network service provider. For example, the subscriber business value may be assessed by the amount of resources of the network the subscriber uses over a period of time, the amount of money the subscriber spends for services over a period of time, or some combination of these and other related factors. A business decision by a network service provider, such as upgrading network 24 or routing traffic on network 24, can be based on the business value of each link in the network, including how much particular links in network 24 are used, on which subscribers use these links, and on the relative subscriber business value of those subscribers.

The business value (i.e., importance) of a link in network 24 is determined. Usage or subscriber data 26 is collected indicating subscribers usage of the various links in network 26. Subscriber business data is also collected. The subscriber business value of each of the subscribers using these various links is determined using the subscriber usage data and subscriber business data. The sum of the business value of all the subscribers at each link represents the importance of that link to network 24 or the link business value. In this way, business decisions can be made that reflect the relative importance of the links in network 26. For example, network upgrades can be focused in such a way that the most important links receive them first or more often. Similarly, if particular links in network 24 are identified as most used by the most valuable subscribers, resources can be focused on and assigned to those links. Also, various combinations of accorded weight can be assigned to the business value of subscribers using links and to the total use of the links to make tailored decisions about allocation of network resources based on this type of usage data.

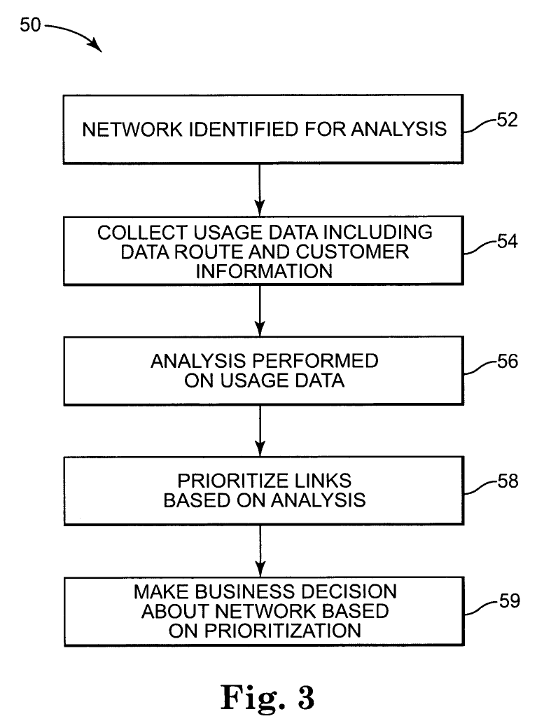

In FIG. 3, a flow diagram illustrating one exemplary embodiment of a method for analyzing network usage according to the present invention is shown generally at 50. Reference is also made to FIGS. 1, 2A and 2B. At 52, a network is identified for analysis. At 54, usage or subscriber data is collected from the network for analysis. The type of usage data collected includes that which can be generated from a network usage data reporting system or a usage data source 12. In one exemplary embodiment, the usage data 26 consists of a real time or real time stream of IDRs received from a network usage data reporting system. The usage data collector 14 collects usage data from the IDRs that may include the type of service and network involved, information about a particular event or communications session between parties such as the session start time and stop time, source or originator of the session, destination of the session, responsible party for accounting purposes, type of data transferred, a usage metric (e.g., bandwidth, megabytes, time), amount of data transferred, quality of service delivered, information about the route data took in moving from source to destination, and information about the subscribers involved in the data transfer.

Subscriber business data is also collected, some of which is determined using the subscriber usage data.

At 56, the collected usage data 26 is analyzed. The analysis includes a calculation of which subscribers consume how much of the resources of network 24. Network subscriber usage associated with each link is determined. Subscriber business value associated with each link is also determined including determining an individual subscriber business value for each subscriber using the plurality of links. In one embodiment, determining an individual subscriber business value includes at least one of identifying services used by each subscriber, identifying pricing plans used by each subscriber, identifying the amount of resources of the network used by each subscriber, and identifying the amount of money each subscriber spends for network services associated with each link. A link business value is determined using the usage data and the subscribing business value associated with each link. In one embodiment, a link business value is determined by summing the subscriber business values for the link.

At 58, links in network 24 are then prioritized based on the analysis of usage data 26. In one embodiment, the most important links are of network 24 are those with the highest sum of link business value. The least important links are those with the lowest sum of link business value.

At 59 a business or engineering decision is made based on the prioritization of the links and analysis of usage data 26. For example, those links identified as most used by the most important subscribers or as having the most business value may be selectively upgraded, as opposed to upgrading the entire network 24, or as opposed to upgrading various links just based on use without regard to whether the links are actually used by the most important subscribers. Usage analysis system 10 accomplishes optimization of network resources in the form of network engineering and network provisioning by analyzing usage data 26, and specifically, by correlating a link and subscriber's business value and network link usage, in making network engineering decisions. With prior systems, network engineering and network provisioning decisions were made by only generally monitoring overall network usage and did not achieve such optimization. Usage analysis system 10 allows a network service provider to make informed decisions about network provisioning and pricing of services. This allows a closer connection between business decisions and network engineering.

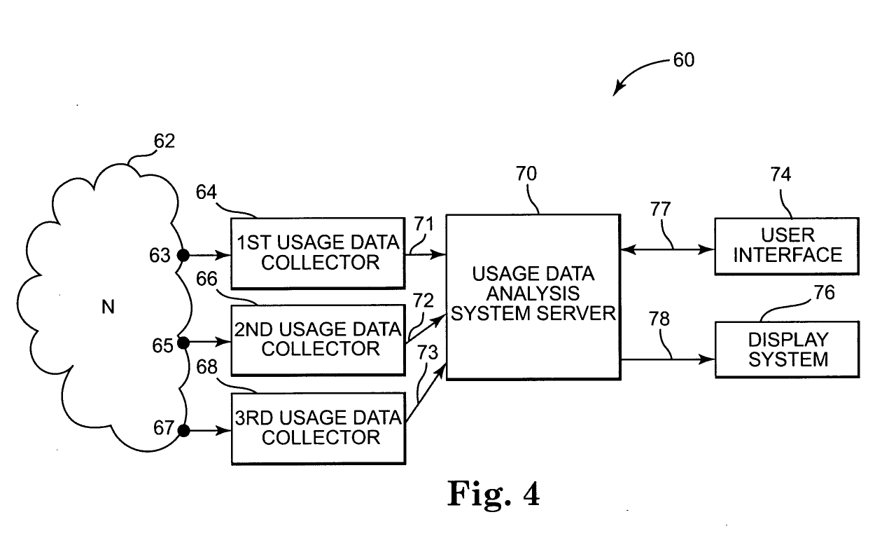

In another embodiment of the present invention, network usage analysis system 60, illustrated in FIG. 4, includes first, second, and third data collectors 64, 66, and 68, usage data analysis system server 70, user interface 74 and display system 76. Usage data collectors 64, 66, and 68 are coupled to network 62 at collection points 63, 65, and 67, respectively. Usage data collectors 64, 66, and 68 are also coupled to usage data analysis system server 70 via communication links 71, 72 and 73, respectively. User interface 74 and display system 76 are coupled to usage data analysis system server 70 via communication links 77 and 78, respectively.

First, second and third usage data collectors 64, 66, and 68 collect usage data at collection points 63, 65 and 67, which in one embodiment correspond to critical routers of network 62. In other embodiments of the invention, additional usage data collectors are added to collect usage data from additional collection points corresponding to additional critical routers of the network. The usage data collected from each of collection points 63, 65 and 67 of the network may include the type of service and network involved, information about a particular event or communications session between parties such as the session start time and stop time, source or originator of the session, destination of the session, responsible party for accounting purposes, type of data transferred, a usage metric (e.g., bandwidth, megabytes, time), amount of data transferred, quality of service delivered, information about the route data took in moving from source to destination and information about the subscribers involved in the data transfer.

Usage data is then transferred from the collectors 64, 66, and 68 (and any additional collectors if applicable) to usage data analysis system server 70. Usage data analysis system server 70 then aggregates the usage data for each of the collection points 63, 65 and 67. In one embodiment, by identifying all of the subscribers that used a particular link associated with a collection point, a total use can be calculated for that collection point or link. Further, a subscriber business value is determined using the subscriber's business information at each collection point or link. For example, weight can be given to the customer segment using the link, the services being used by the subscribers, the pricing plans of the subscribers, and the relative importance of those subscribers.

By collecting usage data from each of the collection points on network, the usage data analysis system server 70, once a link business value is determined the system can prioritize or rank the relative importance of the links. A business decision, such as upgrading network 62 or routing traffic on links in network 62, can be based not only on the amount of use experienced by particular links in network 62, but also on the subscriber business value associated with each link. For example, if particular links in network 62 are identified as most used by valuable subscribers that spend the most on service plans during certain times, resources can be focused on and assigned to those links.

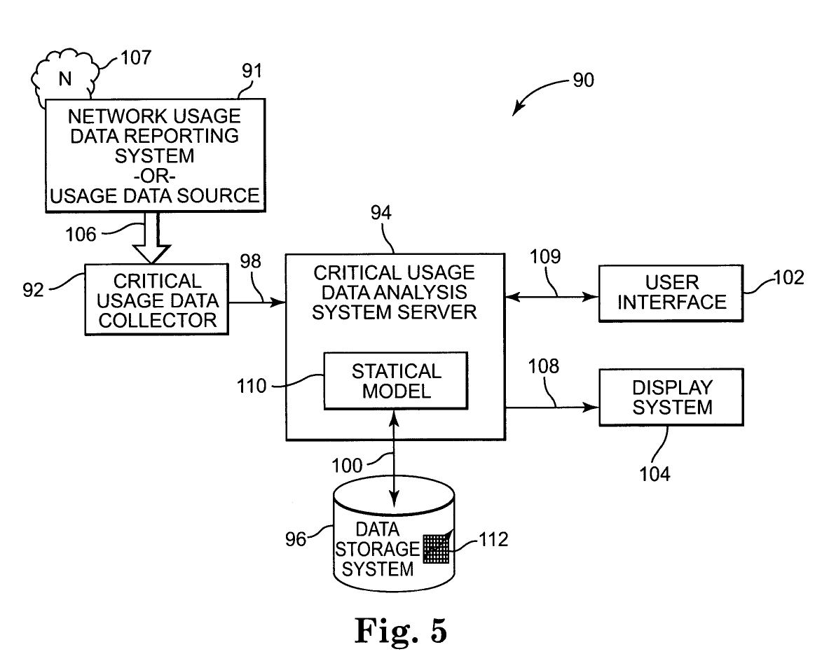

In another embodiment of the present invention, illustrated in FIG. 5, network usage analysis system 90 provides direct statistical representation of usage information and provides compact storage and real time, interactive usage analysis. The network usage analysis system 90 in accordance with the present invention provides for the use of statistical models and the storage of statistical data representative of critical usage data in lieu of storing the critical usage data, thereby allowing for real time interactive statistical analysis and greatly reducing usage data storage requirements. Since statistical models are stored and not the usage data itself, with the present invention the storage requirements do not grow with the amount of usage data. The storage requirements for the statistical models are a function of the complexity of the business to be modeled and the granularity of the desired results.

In one exemplary embodiment, network usage analysis system 90 includes a critical usage data collector 92, a critical usage data analysis system server 94 and a data storage system 96. Critical usage data collector 92 is coupled to critical usage data analysis system server 94 via communication link 98. Data storage system 96 is coupled to critical usage data analysis system server 94 via communication link 100. Network usage analysis system 90 further includes user interface 102 and display system 104. User interface 102 and display system 104 are coupled to critical usage data analysis system server 94 via communication links 109 and 108 respectively.

Critical usage data collector 92 collects critical usage data (e.g., one or more sets of critical usage data) from usage data 106. Preferably, the usage data 106 is a real time stream of network usage data records. In one embodiment, the usage data 106 is a real time stream of IDRs generated from a usage data source or a network usage data reporting system 91, positioned on a network 107 (also indicated by an “N”). As used herein, a network usage data reporting system 90 is one type of usage data source. Alternatively, the IDRs may be received from a database or central data warehouse.

One network usage data reporting system suitable for use with the present invention is commercially available under the tradename SMART INTERNET USAGE, from Hewlett-Packard, U.S.A. Other network usage data reporting systems suitable for use with the usage analysis system in accordance with the present invention will become apparent to those skilled in the art after reading the present application.

Usage data analysis system server 94 receives the critical usage data from the critical usage data collector 92 via communication link 98. In one aspect, the critical usage data collector 92 is separate from a network usage data reporting system, and in another aspect, the critical usage data collector 92 is part of a network usage data reporting system, such that the critical usage data analysis system server 94 receives the set of critical usage data directly from the network usage data reporting system. In another aspect, the critical usage data collector 92 is part of the critical usage data analysis system server 94.

The critical usage data analysis system server 94 uses the set of critical usage data to perform predetermined network usage statistical analysis. In particular, a statistical model 110 is defined for solving a network usage related business problem. The critical usage data analysis system server 94 uses the critical usage data and the statistical model 110 to generate statistical data 112. The critical usage data analysis system server 94 operates to store the statistical data 112 in the data storage system 96. In one aspect, the statistical data is stored in the form of a table (e.g., a distribution table).

After storage of the statistical model 110, the set of critical usage data is no longer retained. In one aspect, the critical usage data analysis system server 94 is responsive to the user interface 102 for interactive analysis of the statistical model 110. Further, a graphical display of the statistical model 110 can be output to display system 104. One exemplary embodiment of interactive analysis of critical usage data using the statistical model 110 is described in related application INTERNET USAGE ANALYSIS SYSTEM AND METHOD, Ser. No. 09/548,124, filed Apr. 12, 2000, which is incorporated by reference herein.

In one embodiment, the statistical model uses subscriber usage data and subscriber business data to determine the subscriber business values associated with each link. The subscriber business values are used to determine a link business value.

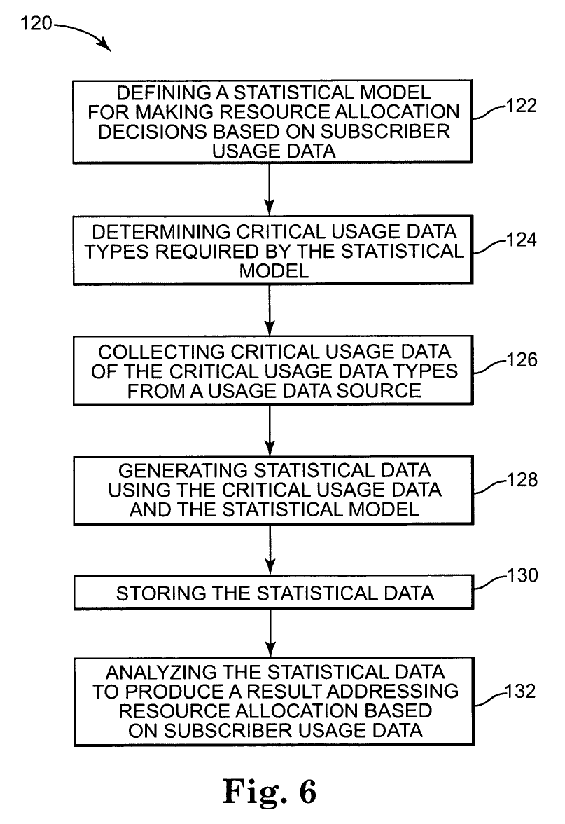

In FIG. 6, a flow diagram illustrating one exemplary embodiment of a method for analyzing a network according to the present invention is illustrated generally at 120. Reference is also made to FIG. 5. At 122, a statistical model is defined for solving a network usage related business problem, such as making a decision on allocation of resource toward maintenance of a network. Such decision can be based on actual usage by subscribers of particular network links and the subscriber business value.

At 124, critical usage data types required by the statistical model are determined. The type of statistical model chosen is based on the network usage related business problem to be solved. By defining only critical usage data types required by the statistical model, the volume of usage data that needs to be collected is greatly reduced. For example, the critical usage data may be information about the route data took in moving from source to destination and information about the subscribers whose data was involved in the transfer.

At 126, critical usage data 98 of the critical usage data types are collected from usage data 106 that can be generated from a network usage data reporting system or a usage data source 91. In one exemplary embodiment, the usage data 106 consists of a real time or real time stream of IDRs received from a network usage data reporting system. A real time stream of IDRs is defined as a stream of IDRs that is “flushed” or transferred from a data storage location at regular and frequent intervals (e.g., which may be substantially instantaneous or, based on the usage data source, from seconds to minutes). The critical usage data collector 92 collects critical usage data from the IDRs that may actual usage by subscribers of particular network links and relative importance of those subscribers.

At 128, statistical data representative of the critical usage data are generated. In particular, statistical data are generated using the critical usage data and the statistical model. The step of generating the statistical data can be done in real time.

At 130, the statistical data are stored. The statistical data may be stored in various forms, such as in the form of a table or graph in volatile or nonvolatile memory. After storing of the statistical data, the critical usage data can be deleted, since it is not necessary to retain it for the selected network usage related business problem. As such, storing of the statistical data representative of the collected critical usage data in lieu of storing the critical usage data itself greatly reduces data storage requirements.

At 132, the statistical data can be analyzed to produce a result addressing the network usage related business problem. Also, the statistical data may be stored in volatile memory (e.g., RAM) to provide for interactive analysis and presentation of results pertinent to a network usage related business problem. The statistical data may be stored and/or archived in non-volatile memory, such as a hard disk drive. In particular, the statistical model is used to determine/analyze usage characteristics. The statistical model may also be used for performing interactive analysis of the critical usage data via user interface 102. In particular, the statistical model may include one or more variable elements, wherein the variable elements are changeable via user interface 102 to interactively model network usage. The statistical model results can be graphically or otherwise displayed using display system 104.

What is claimed is:

1. A method for analyzing a network having a plurality of network links comprising:
determining network subscriber usage associated with each link;
determining a subscriber business value associated with each link; and
determining a link business value associated with each link using the network subscriber usage and the subscriber business value.

2. The method of claim 1, further comprising:
prioritizing the plurality of network links using the link business value.

3. The method of claim 2, further comprising:
making a business decision about the network based on the prioritized links.

4. The method of claim 3, where making a business decision about the network based on the prioritized links includes allocating network resources based on the prioritized links.

5. The method of claim 1, wherein determining the subscriber business value associated with each link includes determining an individual subscriber business value for each subscriber using the plurality of links.

6. The method of claim 5, wherein determining the subscriber business value associated with each link includes calculating a sum of the individual subscriber business values from all the subscribers associated with each link.

7. The method of claim 6, comprising prioritizing the links of the network includes by placing a higher priority on those network links with a higher sum of the individual subscriber business value than links with a lower sum of the individual subscriber business value.

8. The method of claim 6, wherein determining an individual subscriber business value includes at least one of identifying services used by each subscriber, identifying pricing plans used by each subscriber, identifying the amount of resources of the network used by each subscriber, and identifying the amount of money each subscriber spends for network services associated with each link.

9. The method of claim 1, wherein determining a link business value includes identification of links in the network that are most used and identification of subscribers using the most-used links.

10. The method of claim 1, wherein network upgrades are allocated to network links based on the link business value.

11. The method of claim 1, wherein the network comprises an Internet network.

12. The method of claim 1, wherein the network comprises a wireless network.

13. The method of claim 12, wherein the network links comprises a plurality of communication links between network cells.

14. A method for analyzing a network comprising:
determining a subscriber business value associated with each link including determining an individual subscriber business value for each subscriber using the plurality of links including:
collecting subscriber data for the plurality of network links, the subscriber data including subscriber usage data and subscriber business data for each link of the plurality of network links;
aggregating the subscriber data for the plurality of network links;
generating statistical data from the aggregated subscriber data using a statistical model comprising at least one of a histogram, an ordered histogram, a probability density function and a cumulative probability distribution function;
determining the link business value associated with each link from the subscriber business value via the generated statistical data; and
prioritizing the plurality of links using the link business value of each link.

15. The method of claim 14, further comprising requiring storing only of the statistical data.

16. The method of claim 14, wherein generating the statistical data comprises generating the statistical data in substantially real time.

17. The method of claim 14, wherein determining the subscriber business value associated with each link includes calculating a sum of the individual subscriber business values from all the subscribers associated with each link; and wherein prioritizing the links of the network includes by placing a higher priority on those network links with a higher sum of the individual subscriber business value than links with a lower sum of the individual subscriber business value.

18. The method of claim 14, wherein determining an individual subscriber business value includes at least one of identifying services used by each subscriber, identifying pricing plans used by each subscriber, identifying the amount of resources of the network used by each subscriber, and identifying the amount of money each subscriber spends for network services associated with each link.

19. A network analysis system comprising:
a data collector coupled to a network comprising a plurality of links, wherein the data collector collects subscriber data including subscriber usage data and subscriber business data corresponding to a level of use of the plurality of links, an identification of the subscribers using each links, and a subscriber business value associated with subscribers using the links; and
a system server coupled to the data collector, wherein system server receives the subscriber data from the data collector and prioritizes the links based on a link business value including the level of use of the plurality of links, the identification of the subscribers using the links, and on the subscriber business value associated with subscribers using the links.

20. The system of claim 19, wherein the system server generates statistical data based on the subscriber usage data and subscriber business data, and on a predefined statistical model comprising at least one of a histogram, an ordered histogram, a probability density function and a cumulative probability distribution function and the system server prioritizing the links in the network from the generated statistical data.

21. The system of claim 19, further comprising a data storage system for storing only the statistical data.

22. The system of claim 19, wherein the system server updates the statistical data using additionally collected usage data.

23. The system of claim 19, further comprising a user interface operably coupled to the system server.

24. The system of claim 19, wherein the system server is responsive to a user interface for interactive analysis of the statistical model.

25. The system of claim 24, further comprising a display system for displaying the statistical model.

26. The system of claim 19, wherein the statistical model is in the form of one or more tables.

27. A computer readable medium containing instructions for controlling a computer system to perform a method for analyzing a network having a plurality of network links comprising:
instructions for determining network subscriber usage associated with each link;
instructions for determining a subscriber business value associated with each link; and
instructions for determining a link business value associated with each link using the network subscriber usage and the subscriber business value.

28. The medium of claim 30 further comprising:
instructions for prioritizing the plurality of network links using the link business value.
